(19) United States
(12) Patent Application Publication
(10) Pub. No.: US 2013/0342752 A1
(43) Pub. Date: Dec. 26, 2013

(54) IMAGE PICKUP APPARATUS AND METHOD OF CONTROLLING THE SAME

(71) Applicant: CANON KABUSHIKI KAISHA, Tokyo (JP)

(72) Inventor: Atsushi Sugawara, Tokyo (JP)

(21) Appl. No.: 13/912,916

(22) Filed: Jun. 7, 2013

(30) Foreign Application Priority Data
Jun. 25, 2012 (JP) 2012-142081

(51) Int. Cl. H04N 5/232

(52) U.S. Cl. CPC H04N 5/23212
USPC 348/349

(57) ABSTRACT

An image pickup apparatus including an image pickup optical unit which picks up an object image focused by an optical system including a focus lens and acquires an image data from which a refocus image is reconstructable, a driving unit which drives the focus lens, an object detection unit which detects a predetermined object based on the image data, and a refocus image generation unit which reconstructs the refocus image from the image data at an arbitrary focal distance within a refocus range, determines a shift position of the focus lens based on the refocus range to acquire an image data from which the refocus image is reproducible at an arbitrary position in a focus adjustment range, controls the driving unit and the image pickup optical unit according to the determined position to acquire the image data, and detects the predetermined object based on the image data.

### BACKGROUND OF THE INVENTION

1. Field of the Invention

The present invention relates to an image pickup apparatus represented by a digital camera, and more particularly, to an image pickup apparatus having a refocus function and an object detection function and a method of controlling the same.

2. Description of the Related Art

In the related art, there is an image pickup apparatus such as a digital camera which is configured to have a function of detecting an object and an AF/AE function of automatically adjusting focus and exposure in an image area where the detected object exists. Although a function of particularly detecting a face of a person is widely installed as the function of detecting an object, in a case where a depth of field is small and the face is blurred, there is a problem in that the face cannot be detected due to the blur. On the contrary, for example, Japanese Patent Application Laid-Open No. 2009-65356 discloses a technique of shifting a focus lens to a plurality of positions according to the depth of field to perform face detection at the positions. In addition, Japanese Patent Application Laid-Open No. 2008-58553 discloses a technique of driving a focus lens in a direction from the infinite position to the nearest position to determine whether or not the image of the area where a peak contrast value is obtained during the driving is a face image.

On the other hand, “Light Field Photography with a Hand-Held Plenoptic Camera” by Ren. Ng, et al., (seven persons), Stanford Tech Report CTSR 2005-02 etc., discloses an image pickup apparatus having a configuration where a microlens array aligned at a ratio of one to a plurality of pixels is arranged in front of an image pickup element and being capable of obtaining information on an incidence direction of rays of light entering the image pickup element. As applications of such an image pickup apparatus, in addition to generating a general photographed image based on output signals from pixels, there is reconstructing an image which is focused at an arbitrary focal distance, by performing a predetermined imaging process on the photographed image, and the like.

However, in the related art disclosed in the above-described Patent Literatures, since the focus lens basically needs to be scanned from the infinite position to the nearest position, there is a problem in that much time is taken for the AF/AE operation.

### SUMMARY OF THE INVENTION

An aspect of the present invention is to provide an image pickup apparatus capable of detecting an object at a higher speed without an omission in the detection to perform an AF/AE operation in the case where a depth of field is shallow.

In order to achieve the above-described aspect of the invention, according to the present invention, an image pickup apparatus including an image pickup optical unit which picks up an image of an object focused by an optical system including a focus lens for adjusting a focus state of the object and acquires an image data from which a refocus image is able to be reconstructed, a driving unit which drives the focus lens, an object detection unit which detects a predetermined object based on the image data acquired by the image pickup optical unit, and a refocus image generation unit which reconstructs the refocus image at an arbitrary focal distance included within a refocus range from the image data acquired by the image pickup optical unit, Comprises a position determination unit to which determines, based on the refocus range, a position which the focus lens is shifted in an optical axis direction to acquire the image data for reconstructing the refocus image at an arbitrary position within an adjustment range of the focus state of the focus lens; and a control unit which controls the driving unit and the image pickup optical unit according to the position determined by the position determination unit to acquire the image data, wherein the object detection unit detects the predetermined object based on the image data which the control unit acquires by controlling the driving unit and the image pickup optical unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, feature, and aspects of the invention and, together with the description, server to explain the principles of the invention.

FIG. 1 is a block diagram illustrating a whole configuration of an image pickup apparatus according to an embodiment of the present invention.

FIG. 2 is a diagram illustrating a configuration of an image pickup element and a microlens array included in the image pickup apparatus according to the embodiment of the present invention.

FIG. 3 is a diagram illustrating a configuration of an image pickup optical unit including a photographing lens, a microlens array, and an image pickup element in the image pickup apparatus according to the embodiment of the present invention.

FIGS. 4A and 4B are diagrams illustrating a correspondence relation between a pupil area of a photographing lens and a light-receiving pixel in the image pickup apparatus according to the embodiment of the present invention.

FIG. 5 is a conceptual diagram illustrating areas through which a ray of light relating to generation of a refocus image passes in an image pickup optical system of the image pickup apparatus according to the embodiment of the present invention.

FIG. 6 is a diagram illustrating a flowchart of operations of the image pickup apparatus according to the embodiment of the present invention.

FIG. 7 is diagram illustrating a maximum refocus amount of the image pickup apparatus according to the embodiment of the present invention.

FIG. 8 is a diagram illustrating a relation between stop positions of the focus lens and a refocus range in object direction according to the embodiment of the present invention.

FIGS. 9A, 9B, 9C and 9D are diagrams illustrating an example of setting lens shift positions when a plurality of objects are detected in the objection detection according to the embodiment of the present invention.

FIG. 10 is a diagram illustrating a relation between stop positions of the focus lens and a refocus range according to a modified example of the embodiment of the present invention.

### DESCRIPTION OF THE EMBODIMENTS

Various exemplary embodiments, features, and aspects of the present invention will be described in detail below with reference to the drawings.

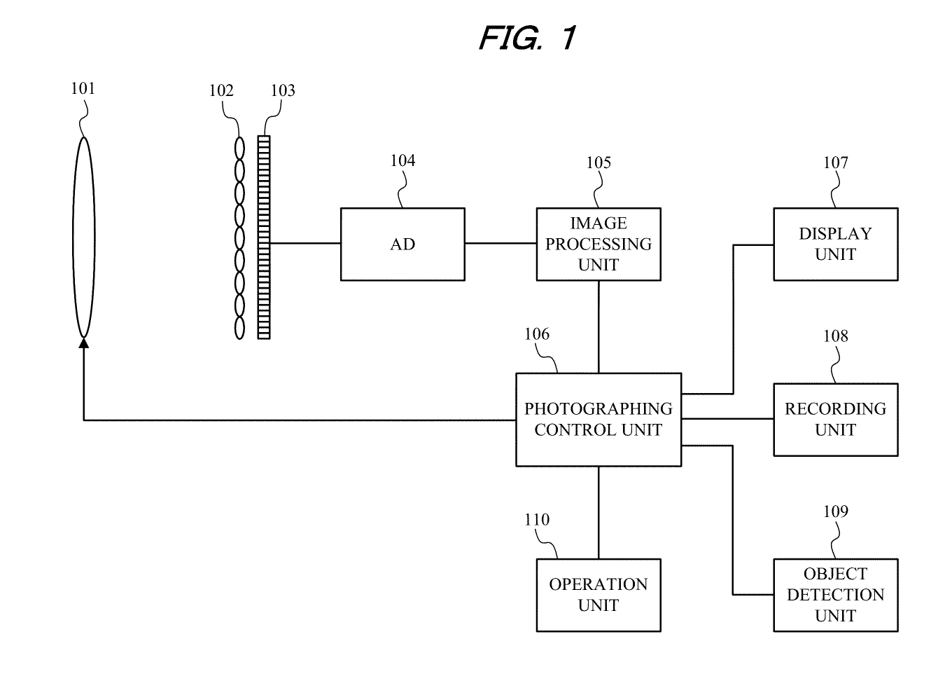

FIG. 1 is a block diagram illustrating a digital camera as an image pickup apparatus according to an embodiment of the present invention. In this figure, reference numeral 101 denotes a photographing lens, which is an optical system configured with a plurality of lenses although not illustrated. The plurality of lenses includes a movable focus lens. A focus state for an object can be adjusted by driving the focus lens. Reference numeral 102 denotes a microlens array (hereinafter, referred to as an “MLA”), which is configured with a plurality of microlenses. The microlens array is arranged in the periphery of a focal point of the photographing lens 101. Rays of light passing through different pupil areas of the photographing lens 101 enters the MLA 102 and exit separately from the respective pupil areas. Reference numeral 103 denotes an image pickup element, which is configured with a CCD image sensor, a CMOS image sensor, or the like. The image pickup element is arranged in the periphery of a focal point of the MLA 102. The details of the MLA 102 and the image pickup element 103 will be described later. Reference numeral 104 is an AD conversion unit, which performs AD conversion on an image signal output from the image pickup element 103 to generate a digital data, and an image processing unit denoted by reference numeral 105 performs a predetermined imaging process and the like on the digital data to obtain a digital image data of the object. Reference numeral 106 is a photographing control unit, which displays the digital image data obtained by the image processing unit 105 on a display unit 107 configured with a liquid crystal display or the like and performs controlling such as storing the data in a recording unit 108. A CPU of the photographing control unit 106 loads and executes a program stored in a memory (not illustrated) to perform controlling the respective components of the image pickup apparatus. In this case, all or a portion of the functions of the components may be executed by the CPU, or may be configured as hardware.

An object detection unit 109 receives the digital image data obtained by the image processing unit 105 from the photographing control unit 106 to detect a position and size in an image frame of a predetermined object, which exists in an image. In the present embodiment, the object detection unit 109 has a function of detecting a person's face as the predetermined object to detect the position and size thereof in the image frame. In addition, a feature data of a face of a specific person is registered in advance, and individual identification can be performed by comparing the detected face with the registered data. Due to the identification function, priority can be allocated to the detected face of the specific person.

An operation unit 110 is a unit such as a button or a touch panel, which receives manipulation from a user. In response to the received manipulation, various operations such as starting of a focusing operation or erasing of the digital image data stored in the recording unit 108 are performed. In addition, the photographing lens 101 is electrically and mechanically connected to the photographing control unit 106, so that information on the photographing lens can be acquired through communication, and a focus lens driving command or the like may be transmitted at the time of the focusing operation.

Next, configurations of the photographing lens 101, the MLA 102, and the image pickup element 103 in the image pickup apparatus according to the present embodiment will be described.

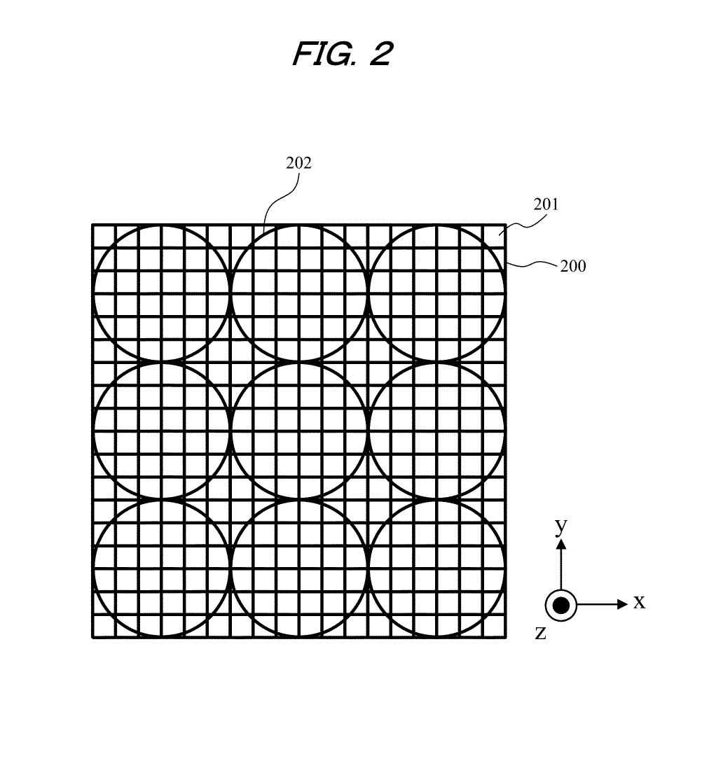

FIG. 2 is a diagram illustrating configurations of the image pickup element 103 and the MLA 102. This figure shows the image pickup element 103 and the MLA 102, when viewed along the z direction parallel to the optical axis of the photographing lens. One microlens 202 is arranged so as to correspond to a plurality of unit pixels 201 (photoelectric conversion elements) constituting a virtual pixel 200 of a photographed image. The microlens 202 is one of the microlenses constituting the MLA 102. In the present embodiment, it is assumed that 6 rows×6 columns (total 36) unit pixels 201 correspond to one microlens. In addition, with respect to the coordinate axes illustrated in this figure, the optical axis direction is indicated by the z axis; and a plane perpendicular to the z axis is set as a plane parallel to the image pickup plane, and the x axis (horizontal direction) and the y axis (vertical direction) are defined in the image pickup plane. In addition, FIG. 2 illustrates a portion of a light receiving plane of the image pickup element 103, and a large number of pixels are arranged in an actual image pickup element.

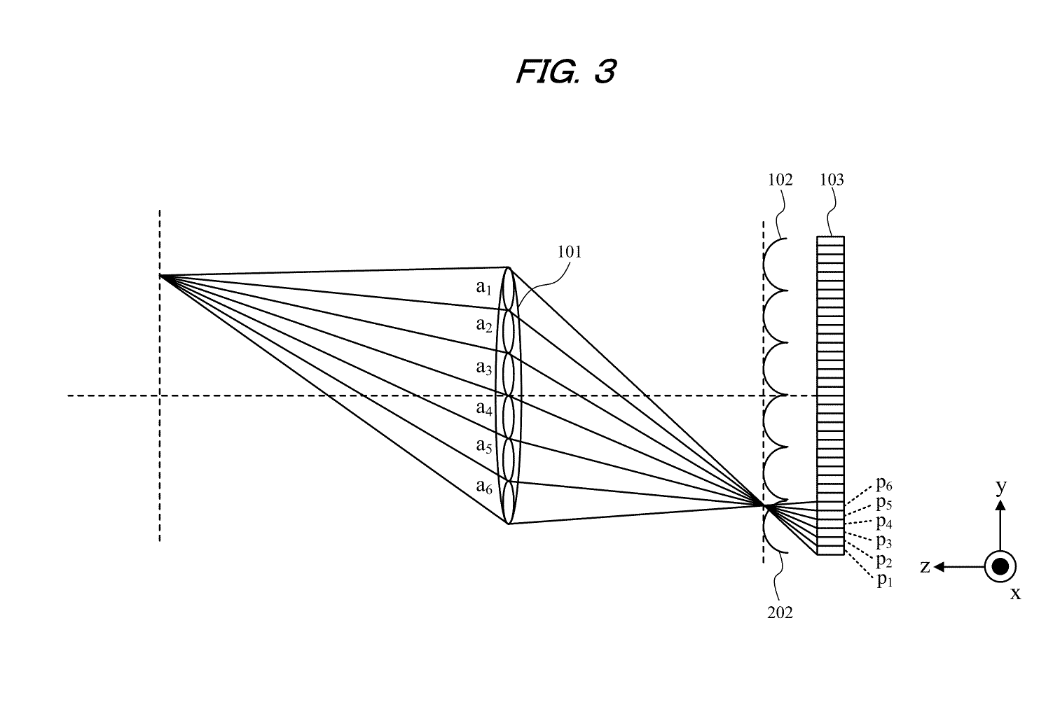

FIG. 3 is a diagram illustrating a state where rays of light exiting from the photographing lens 101 pass through one microlens 202 of the MLA 102 to be received by the image pickup element 103, when viewed in the direction perpendicular to the optical axis z. The rays of light exiting from the pupil areas a₁ to a₆ of the photographing lens 101 and passing through the microlens 202 are focused onto corresponding unit pixels p₁ to p₆ of the image pickup element 103.

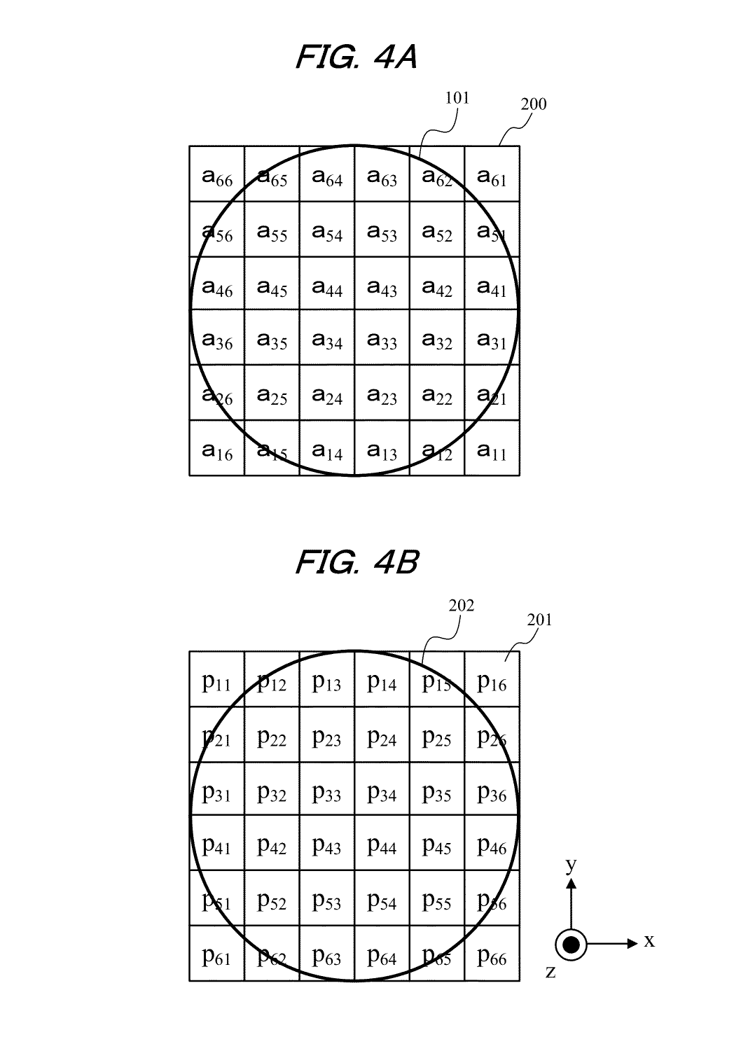

FIG. 4A is a diagram illustrating an aperture of the photographing lens 101, when viewed in the optical axis (z-axis) direction. FIG. 4B is a diagram illustrating the one microlens 202 and the unit pixels 201 arranged after the microlens 202, when viewed in the optical axis (z-axis) direction. As illustrated in FIG. 4A, in a case where the pupil area of the photographing lens 101 is divided into areas of which the number is the same as the number of the pixels arranged under one microlens, the rays of light from one of the pupil-division areas of the photographing lens 101 are focused onto one pixel. Herein, it is assumed that the F number of the photographing lens and the F number of the microlens are almost equal to each other. When the pupil division areas of the photographing lens illustrated in FIG. 4A are denoted by a₁₁ to a₆₆ and the pixels illustrated in FIG. 4B are denoted by p₁₁ to p₆₆, the pupil division areas and the pixels have a relation of point symmetry, when viewed in the optical axis (z-axis) direction. Therefore, the rays of light exiting from the pupil division area a₁₁ of the photographing lens are focused on the pixel p₁₁ among the pixels 201 arranged after the microlens. In this manner, the rays of light exiting from the pupil division area a₁₁ and passing through different microlenses are also focused on the pixel p₁₁ among the pixels 201 arranged after the microlens.

Next, a process of reconstructing the digital image data, which is acquired by using an image pickup optical unit including the photographing lens 101, the MLA 102, and the image pickup element 103, in an image at an arbitrarily-set focal point (refocus plane) will be described. The reconstruction is performed by using a method called “Light Field Photography” in the image processing unit 105.

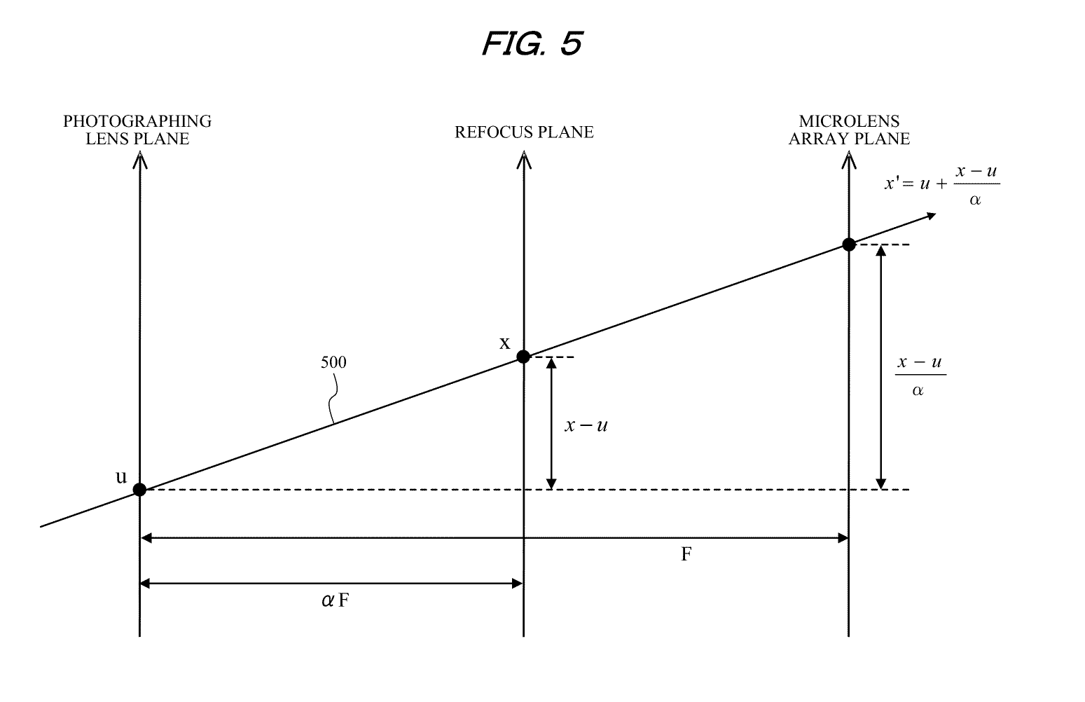

FIG. 5 is a diagram illustrating from which pupil division area of the photographing lens a ray of light passing through a pixel on an arbitrarily-set refocus plane exists and which microlens the ray of light enters, when viewed from the direction perpendicular to the optical axis (z axis). As illustrated in this figure, a coordinate of a position of a pupil division area of the photographing lens is denoted by (u, v); a coordinate of a position of a pixel on the refocus plane is denoted by (x, y); and a coordinate of a position of a microlens on the microlens array is denoted by (x′, y′). In addition, a distance from the photographing lens to the microlens array is denoted by F; and a distance from the photographing lens to the refocus plane is denoted by αF. Herein, a denotes a refocus coefficient for determining a position of the refocus plane, which can be arbitrarily set by the user. In addition, in FIG. 5, only the directions of u, x, and x′ are illustrated, but the directions of v, y, and y′ are omitted.

As illustrated in FIG. 5, a ray of light 500 passing through the coordinate (u, v) and the coordinate (x, y) reaches the coordinate (x′, y′) of the microlens array. The coordinate (x′, y′) can be expressed by Equation 1.

$$( {x}^{′} , {y}^{′} ) = ( u + \frac{x - u}{α} , v + \frac{y - v}{α} ) \qquad Equation 1$$

In addition, when an output of the pixel which receives the ray of light 500 is denoted by L(x′, y′, u, v), an output E(x, y) obtained at the coordinate (x, y) of the refocus plane is an integration of the L(x′, y′, u, v) with respect to the pupil areas of the photographing lens. Therefore, the output E(x, y) can be expressed by Equation 2.

$$E ( x , y ) = \frac{1}{{α}^{2} {F}^{2}} \int \int L ( u + \frac{x - u}{α} , v + \frac{y - v}{α} , u , v ) d u d v \qquad Equation 2$$

In Equation 2, since the refocus coefficient α is determined by the user, if the positions (x, y) and (u, v) are given, the position (x′, y′) of the micro lens where the ray of light 500 enters can be identified. In addition, the pixel corresponding to the position (u, v) can be identified among a plurality of the pixels corresponding to the microlens, and the output of this pixel becomes L(x′, y′, u, v). The process is performed over all the pupil division areas, and the obtained outputs of the pixels are summed up (integrated), so that E(x, y) can be calculated.

In addition, if (u, v) is a representative coordinate of the pupil division area of the photographing lens, the integration in Equation 2 can be calculated through simple addition.

In this manner, the calculation process of Equation 2 is performed, so that an image at an arbitrary focal point (refocus plane) can be reconstructed.

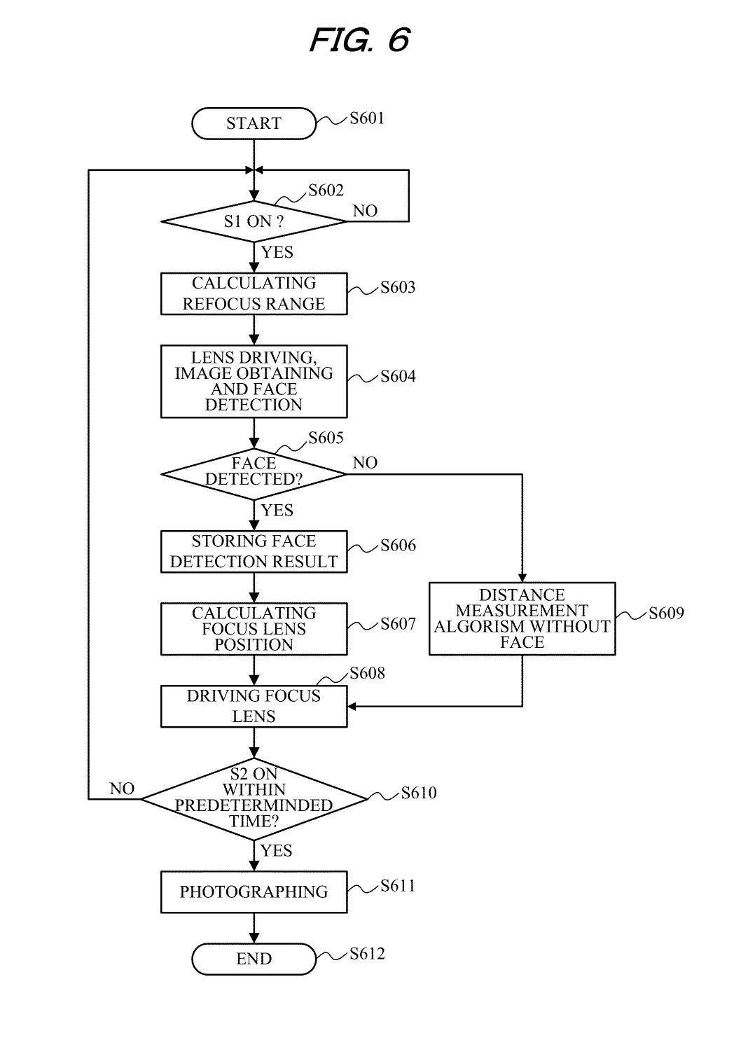

Next, a flowchart of operations of the image pickup apparatus according to the embodiment will be described with reference to FIG. 6. In addition, as described above, the operations are performed by allowing the CPU of the photographing control unit 106 to execute a program to control the components.

When the procedure starts in Step S601, it is waited for in Step S602 that a switch S1 is turned on. The switch S1 denotes a switch (not illustrated) included in the operation unit 110. When the switch is turned on, a before-photographing preparation operation such as exposure measurement or autofocusing starts. Actually, the above-described switch is a two-state depression type push button switch which detects two states of a half depression state and a full depression state. In the half depression state, the switch S1 is turned on; and in the full depression state, a switch S2 is turned on. In general, in an image pickup apparatus such as a digital camera, if the switch S1 is turned on, a photographing preparation operation is performed; if the switch S2 is turned on, a main photographing (exposure) operation is performed.

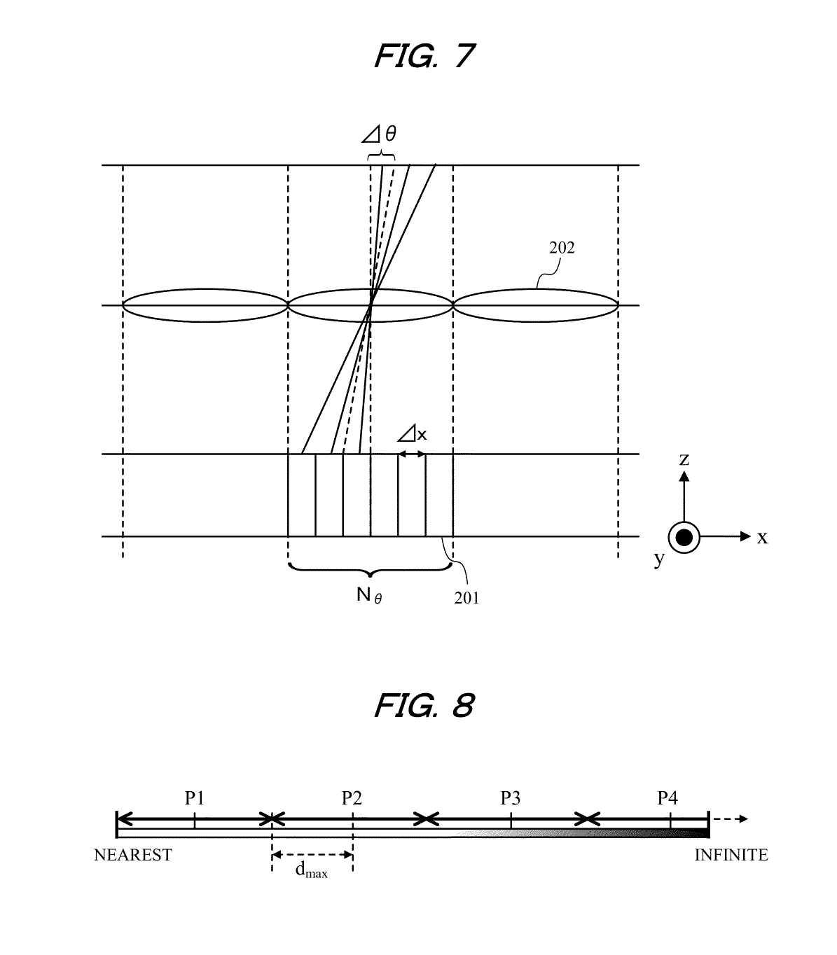

Upon turn-on of the switch S1, a refocusable range is calculated in a step S603. For the refocusable range, the maximum refocus amount range dₘₐₓ is calculated using an equation 3, in a case where an angular resolution Δθ, the number N_{θ} of divided angles, and a pixel pitch Δx are provided as shown in FIG. 7.

$${d}_{max} = \frac{{N}_{θ} \cdot Δ x}{tan ( Δθ )} \qquad Equation 3$$

Accordingly, it can be understood that a refocus image can be generated in a defocus range of −dₘₐₓ to +dₘₐₓ.

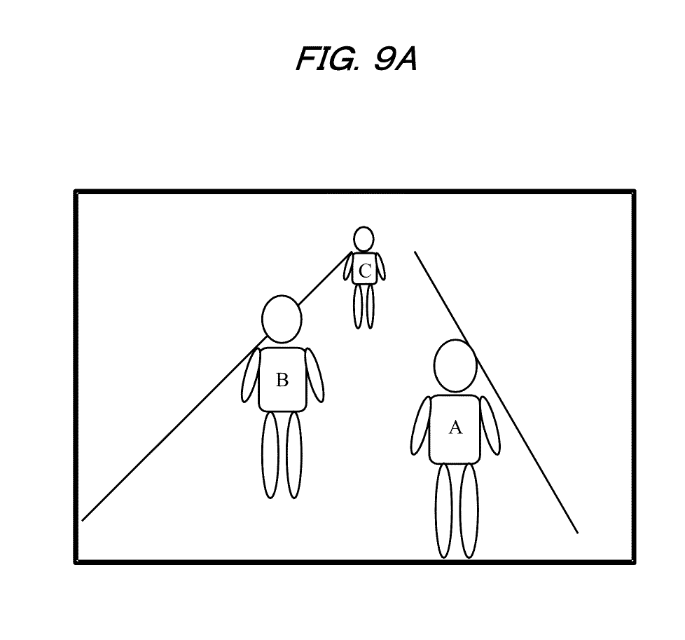

However, in the design of the image pickup apparatus, generally, the refocus range is not so wide as the entire focus area (adjustment range of focus state) covered from the nearest side to the infinite side by the photographing lens 101. FIG. 8 is a schematic diagram illustrating a relation between the refocus range according to the present embodiment and the entire focus area covered from the nearest side to the infinite side by the photographing lens. In this figure, the refocusable ranges of ±dₘₐₓ are indicated by bold arrows. Four bold arrows cover the entire focus areas covered from the nearest side to the infinite side by the photographing lens. In other words, the focus lens is allowed to be stopped at four points P1, P2, P3, and P4 (in the interval of the refocus range) to acquire the image data of the object. Then, the refocus image is reconstructed from the acquired image data, so that the image data which can provide a focused image at all the distances ranging from the nearest position to the infinite position can be generated. In this manner, in Step S603, stop positions (shift positions) of the focus lens necessary for covering all the focus areas are determined from information on the nearest-infinite range of the lens and the result of calculation of the refocus range.

Next, in Step S604, the lens is driven to be at the stop positions of the focus lens determined in Step S603 to acquire the image data of the object, which can reconstruct the refocus image, and a face is detected in the acquired image data. The face detection is performed by the object detection unit 109, and a plurality of the image data acquired in Step S603 and a plurality of the refocus image reconstructed from the image data are input, so that the face can be detected at all object distances.

In Step S605, it is determined whether or not a face is detected in Step S604. In a case where a face is detected, the procedure proceeds to Step S606 to store in a memory (not illustrated) the focus position of the face-detected image and the position and size of the face in the detected image; and subsequently the procedure proceeds to Step S607. In a case where no face is detected, the procedure proceeds to Step S609.

In Step S607, an optimal position of the focus lens is determined according to the detected face. If one face is detected, then the focus lens is driven to the position where the face is included within the refocus range, to acquire the image data, so that an image which is focused onto the face can be reconstructed from the acquired image data by using the refocus process.

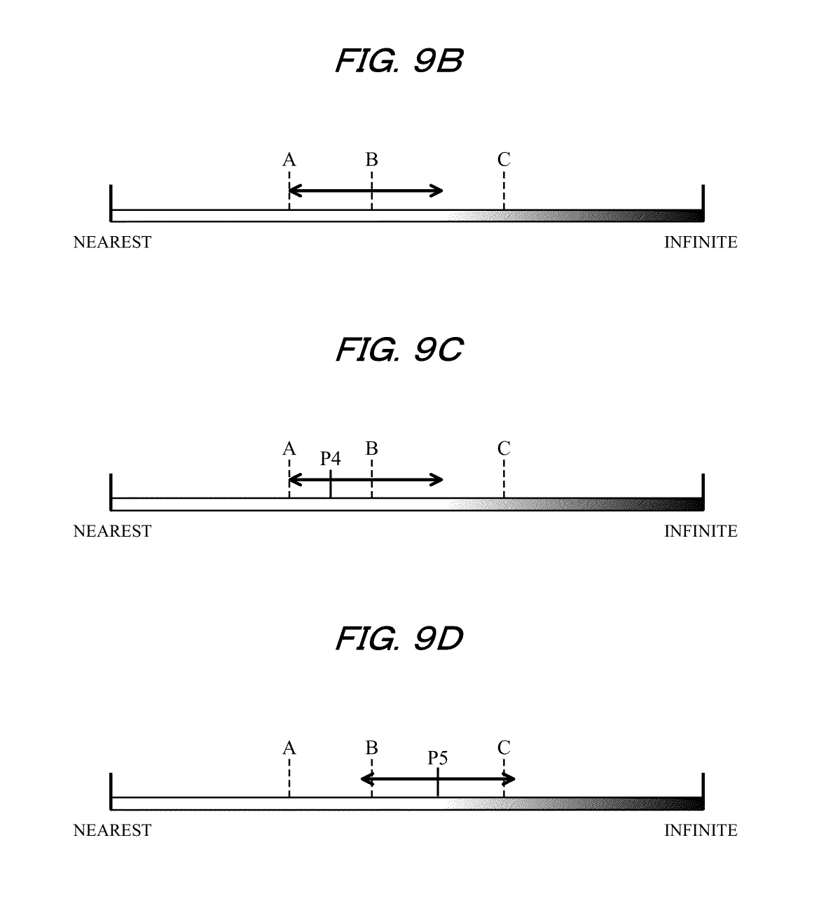

However, in a case where a plurality of faces is detected, various processes may be considered. For example, as illustrated in FIG. 9A, the case where persons A, B, and C as objects exist at different object distances is considered. The information on the objects is stored as object detection information in Step S606. Since the person A exists at the nearest position, the size of the detected face is the largest. The size of the face is decreased in the order of the person B and the person C, and the distance thereof is increased. In this situation, it is assumed that the object distances may be so illustrated in a lens driving range that three persons exist at different focus positions as illustrated in FIG. 9B. In this case, if only one photographed image is acquired and stored and subsequently a refocus process can be performed to allow to focus onto each of the persons A, B, and C, this is the most preferable. However, as illustrated in FIG. 9B, there may also be a case where there is no position of the focus lens where all the three persons A, B, and C are included within one refocus range (all the persons A, B, and C cannot be covered by one bold arrow). Therefore, for example, the method of allocating priority to the face of the person A which is detected at the nearest position with the largest size of face is used. In this case, it can be understood that, if the focus lens is driven to the position P4 as illustrated in FIG. 9C, the person B can also be allowed to be included within the refocus range. If the image data is acquired according to the setting of this refocus range, the images which are focused onto the persons A and B can be reconstructed from the acquired image data in a post processing. On the other hand, for example, in a case where the face of the person C is a face of a person registered in an inner component of the camera, the method of allocating priority to the person C is used. At this time, as illustrated in FIG. 9D, if the position P5 is a stop position of the focus lens, the person C and the person B can be allowed to be included within the refocus range, so that the images which are focused onto the persons B and C can be reconstructed in a post process. In this manner, in Step S607, the shift position of the focus lens is obtained so that as many faces as possible (the largest number of the faces) can be allowed to be included within the refocus range according to the distances and priorities of the detected faces and the refocus range. In addition, photographing may be performed at both of the positions P4 and P5 of focus lens so that the images which are focused onto all the persons A, B, and C can be obtained. If the position of the focus lens at the time of photographing is determined in Step S607, the focus lens is actually driven to the position in Step S608.

On the other hand, in a case where no face is detected in Step S605, the position of the focus lens is determined through a distance measurement algorithm for the case of no-face detection in Step S609. For example, an image frame is divided into nine (3×3) areas to perform distance measurement to each divided area, and the position of the focus lens where the area which is nearest as a result of the distance measurement is focused is calculated based on the acquired information of the distance measurement. Herein, although the case where the image frame is divided into nine areas and the area is selected based on the distance measurement where priority is allocated to the nearest side is exemplified, the number of positions where distance measurement is performed and the priority allocated to the nearest side are merely examples, and thus not limited to those.

If the focus lens is driven to a predetermined position in Step S608, it is waited for in Step S610 that the switch S2 is turned on. If the switch S2 is turned on within a predetermined time after the switch S1 is turned on, an exposure operation is performed in Step S611, so that the sequence of the procedure ends. In a case where the switch S2 is not turned on within a predetermined time Or in a case where the switch S1 is turned off, the procedure returns to Step S602. According to the present invention, it is possible to provide an image pickup apparatus having an object detection function and an AF/AE function, which can detect objects included in several focus ranges at a high speed to perform photographing.

Now, reduction of the number of stop positions of the focus lens determined in Step S603 of the above-described embodiment is considered. The flowchart of operations of the image pickup apparatus is the same as that of the first embodiment except that a depth of field is taken into consideration in the determination of stop positions of the focus lens in Step S603. Hereinafter, only the different point will be described, and the description of the same components will be omitted.

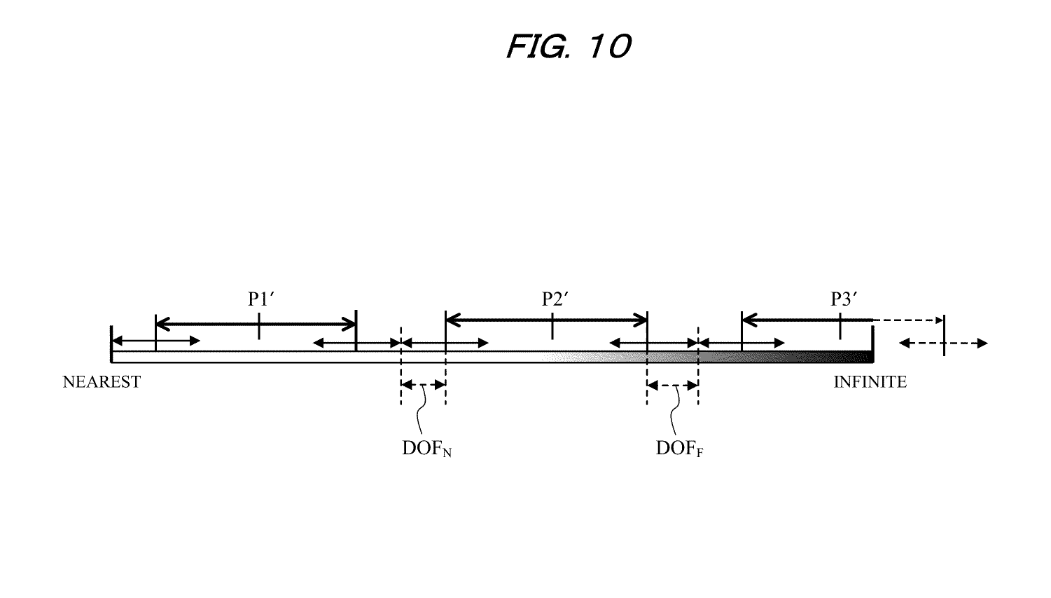

In general, according to a face sensing function, a face can also be detected from an image in which the face is not completely focused and is somewhat blurred. Therefore, for example, a depth of field at a time of acquiring is calculated, and if it is considered that a face within the depth of field can be detected, as illustrated in FIG. 10, the number of stop positions of the focus lens can be reduced. In other words, as illustrated in FIG. 10, if the depths of field are indicated by thin-line arrows, the face detectable range is widened by the depths of field at the both ends of the refocus range in addition to the refocus ranges indicated by bold solid lines. For example, the stop positions of the focus lens may be set to three points P1′, P2′, and P3′. In addition, the depth of field can be divided into a front depth of field DOF_{N} and a backward depth of field DOF_{F}. If a diameter of a permissible circle of confusion, an iris value, an object distance, and a focal distance are denoted by δ, F, a, and f, respectively, the front depth of field DOF_{N} and the backward depth of field DOF_{F} are expressed as follows.

$${DOF}_{N} = \frac{δ \cdot F \cdot {a}^{2}}{{f}^{2} + δ \cdot F \cdot a}$$

$${DOF}_{F} = \frac{δ \cdot F \cdot {a}^{2}}{{f}^{2} - δ \cdot F \cdot a}$$

According to the above-described modified example, it is possible to reduce the number of stop positions of the focus lens necessary for the object detection in comparison to the first embodiment, so that it is possible to further shorten the time necessary for the object detection. After the determination of the stop positions, the same photographing operations as those of the first embodiment are performed.

As described hereinbefore, according to the present invention, it is possible to provide an image pickup apparatus having an object detection function and an AF/AE function, which can detect objects included in several focus ranges at a high speed to perform photographing.

As described above, the processes illustrated in FIG. 6 may be implemented as functions by allowing the CPU of the photographing control unit and the like to read programs for implementing the functions of the processes from a memory (not illustrated) and to execute the programs.

However, the present invention is not limited to the above-described configuration, but all or a portion of the functions of the processes illustrated in FIG. 6 may be implemented by using dedicated hardware. In addition, the above-described memory may be configured with a computer-readable, writable recording medium. For example, the above-described memory may be a recording medium configured with a magneto-optical disk device, a non-volatile memory such as a flash memory, a read-only recording medium such as a CD-ROM, a volatile memory excluding a RAM, or a combination thereof.

In addition, programs for implementing functions of the processes illustrated in FIG. 6 may be recorded in a computer-readable recording medium, and a computer system may be allowed to read and execute the programs recorded in the recording medium, so that the processes may be performed. In addition, the above-described “computer system” may include an OS and hardware such as peripheral apparatuses. More specifically, in some cases, the programs read from the recording medium may also be written in a memory installed in a function extension board inserted into a computer or a function extension unit connected to the computer. In this case, after the program is written, the CPU and the like installed in the function extension board or the function extension unit is allowed to execute a portion of or all of the actual processes based on instructions of the program, so that the functions of the above-described embodiment can be implemented by the processes.

In addition, the “computer-readable recording medium” denotes a flexible disk, an optical magnetic disc, a portable medium such as a ROM and a CD-ROM, and a storage apparatus such as a hard disk built in the computer system. Furthermore, the “computer-readable recording medium” also includes a volatile memory (RAM) in the computer system which is a server or a client in a case where the program is transmitted through a network such as the Internet or through a communication line such as a telephone line. In this manner, a device which stores the program in a predetermined time is also included in the “computer-readable recording medium”.

In addition, the program may be transmitted through a transmission medium from a computer system where the program is stored in a storage apparatus or the like, or the program may be transmitted to other computer systems by a transmission wave in a transmission medium. Herein, the “transmission medium” through which the program is transmitted denotes a medium having a function of transmitting information, for example, a network (communication network) such as the Internet, a communication line such as a telephone line, or the like.

In addition, the program may also be a program for implementing a portion of the above-described functions. In addition, the program may also be implemented as a combination of the above-described function and a program recorded in advance in a computer system, which is called a differential file (differential program).

In addition, a program product such as a computer-readable recording medium where the above-described program is recorded may be adapted as an embodiment of the present invention. The above-described program, recording medium, transmission medium, and program product are included in the scope of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-142081, filed on Jun. 25, 2012, which is hereby incorporated by reference herein in its entirety.

What is claimed is:

1. An image pickup apparatus including an image pickup optical unit which picks up an object image focused by an image pickup optical system including a focus lens for adjusting a focus state of the object and acquires an image data from which a refocus image is reconstructable, a driving unit which drives the focus lens, an object detection unit which detects a predetermined object based on the image data acquired by the image pickup optical unit, and a refocus image generation unit which reconstructs the refocus image at an arbitrary focal distance included within a refocus range from the image data acquired by the image pickup optical unit, comprising:
a position determination unit which determines, based on the refocus range, a position to which the focus lens is to be shifted to in an optical axis direction to acquire the image data for reconstructing the refocus image at an arbitrary position within an adjustment range of the focus state of the focus lens; and
a control unit which controls the driving unit and the image pickup optical unit according to the position determined by the position determination unit to acquire the image data,
wherein the object detection unit detects the predetermined object based on the image data which the control unit acquires by controlling the driving unit and the image pickup optical unit.

2. The image pickup apparatus according to claim 1, wherein the position determination unit determines the adjustment range of the focus state as shift positions of the focus lens which is shifted in an interval of the refocus ranges, and wherein the refocus ranges corresponding to the shift positions do not overlap with each other and include the adjustment range.

3. The image pickup apparatus according to claim 1, wherein the position determination unit determines the adjustment range of the focus state as shift positions of the focus lens which is shifted in an interval of a range provided by expending each of the both ends of the refocus range by the depth of field, and wherein the extended refocus ranges corresponding to the shift positions do not overlap with each other and include the adjustment range.

4. The image pickup apparatus according to claim 1, wherein the object detection unit detects the predetermined object from the image data which the control unit acquires by controlling the driving unit and the image pickup optical unit and the refocus image which is reconstructed from the image data by the refocus image generation unit.

5. The image pickup apparatus according to claim 1, wherein the control unit determines the shift position of the focus lens for picking up the detected predetermined object, based on the refocus range and a range where the detected predetermined object is sensible, and the control unit controls the driving unit and the image pickup optical unit according to the shift position of the focus lens for picking up the detected predetermined object.

6. The image pickup apparatus according to claim 5, wherein, in a case where the object detection unit detects a plurality of objects at different positions, the control unit determines the shift positions of the focus lens which provide the refocus ranges including the positions of the plurality of the detected objects or the positions of the maximum number of objects, as the shift positions of the focus lens for picking up the detected predetermined object image.

7. The image pickup apparatus according to claim 6, wherein, in a case where the control unit determines the shift positions of the focus lens which provide the refocus ranges including the positions of the maximum number of objects among the plurality of the detected objects, as the shift positions of the focus lens for picking up the detected predetermined object, the control unit controls the refocus image generation unit to reconstruct an image of a predetermined object which is not included in the refocus range, as a refocus image.

8. The image pickup apparatus according to claim 1, wherein the object detection unit detects a face of a person as the predetermined object.

9. The image pickup apparatus according to claim 8, wherein the object detection unit detects a distance of the person and a size of the face of the person, and wherein the control unit determines the shift position of the focus lens for picking up the detected predetermined object, based on the detected distance of the person and the detected size of the face of the person.

10. The image pickup apparatus according to claim 1, wherein, in a case where the object detection unit does not detect the predetermined object, the control unit determines the shift position of the focus lens based on information of distance measurement which is obtained by adjusting the focus state of the focus lens.

11. A method of controlling an image pickup apparatus including an image pickup optical unit which picks up an object image focused by an image pickup optical system including a focus lens for adjusting a focus state of the object and acquires an image data from which a refocus image is reconstructable, a driving unit which drives the focus lens, an object detection unit which detects a predetermined object based on the image data acquired by the image pickup optical unit, and a refocus image generation unit which reconstructs the refocus image at an arbitrary focal distance included within a refocus range from the image data acquired by the image pickup optical unit, comprising the steps of:
determining, based on the refocus range, a position which the focus lens is to be shifted to in an optical axis direction to acquire the image data for reconstructing the refocus image at an arbitrary position within an adjustment range of the focus state of the focus lens; and
controlling the driving unit and the image pickup optical unit according to the position determined in the determining step,
wherein the object detection unit detects the predetermined object based on the image data acquired by controlling the driving unit and the image pickup optical unit in the controlling step.

12. A non-transitory computer-readable storage medium storing a program comprising a program code for executing the control method according to claim 11.
